(19) United States
(12) Patent Application Publication
(10) Pub. No.: US 2025/0119811 A1
(43) Pub. Date: Apr. 10, 2025

(54) RESILIENT WIRELESS HELIOSTATS COMMUNICATION SYSTEM

(71) Applicant: UNM RAINFOREST INNOVATIONS, Albuquerque, NM (US)

(72) Inventors: Eirini Eleni TSIROPOULOU, Albuquerque, NM (US); Aisha B. RAHMAN, Albuquerque, NM (US); Md Sadman SIRAJ, Albuquerque, NM (US)

(21) Appl. No.: 18/912,173

(22) Filed: Oct. 10, 2024

Related U.S. Application Data
(60) Provisional application No. 63/610,786, filed on Dec. 15, 2023.
(60) Provisional application No. 63/589,136, filed on Oct. 10, 2023.

(51) Int. Cl. H04W 40/08; H04W 40/10; H04W 40/12

(52) U.S. Cl. CPC H04W 40/08; H04W 40/10; H04W 40/12

(57) ABSTRACT

The HELIOCOMM technology enables wireless heliostats to communicate with a central station in a wireless manner following the principles of the Integrated Access and Backhaul (IAB) technology, artificial-intelligent heliostats clustering, entropy-based routing, and resource allocation to support the closed-loop autocalibration and controls in Solar Tower Power Plant (STPP) facilities, while transitioning from wired to wireless communication.

### RELATED APPLICATIONS

This application claims priority under 35 U.S.C. § 119 (e) to U.S. Provisional Patent Application No. 63/589,136, filed Oct. 10, 2023, and U.S. Provisional Patent Application No. 63/610,786, filed Dec. 15, 2023, which applications are incorporated herein by reference.

### BACKGROUND OF THE INVENTION

A heliostat device includes a moveable mirror to constantly reflect sunlight toward a predetermined target. Solar Tower Power Plant (STPP) facilities, which use heliostats to redirect solar radiation for energy conversion, face high communication infrastructure costs. To address this issue, wireless heliostats supported by photovoltaic (PV) panels and a wireless communication link to the central station, which controls the calibration, cleaning, and the overall operation of the heliostats, are gaining interest.

Traditional wired networks are characterized by significant costs (i.e., trenching, cabling, labor, and land preparation), making wireless communication a cost-effective alternative. Research efforts have focused on wireless-controlled heliostat fields. Existing studies have primarily focused on basic wireless network development without thoroughly studying critical aspects such as minimizing the communication latency to support closed-loop control operation in STPP and maximizing energy efficiency. Maximizing energy efficiency is of paramount importance as the wireless modules on each heliostat rely on the harvested photovoltaic (PV) energy, which is also used for the mechanical control and calibration functions of the heliostats. There is a need for energy-efficient wireless communication.

In recent applications of wireless communication systems within heliostat fields, mesh networking technology has been employed to facilitate bidirectional data transmission between individual heliostats and the central station. However, over extended multi-hop distances, signal attenuation may lead to a significant reduction in the received signal strength at the central station's receiver. As a consequence, the received message may not be successfully decoded, resulting in message loss and necessitating retransmission. Such scenarios lead to heightened communication overhead within an already constrained bandwidth environment and may introduce detrimental latency that could severely impact the STPPs operational efficiency.

Within an expansive heliostat field, the interactions between various heliostats' transmissions result in the emergence of radio frequency (RF) interference. This interference exhibits an exponential rise, particularly when facilitating long-distance transmissions. Moreover, the shared utilization of the same frequency band, a frequent occurrence in the 2.4/5/6 GHz spectrum bands, by other devices in the vicinity further contributes to the elevation of RF interference levels. Furthermore, the electronic and mechanical components within the heliostats themselves generate electromagnetic (EM) interference, introducing interference into the transmitted signals.

The substantial physical dimensions of the heliostats, along with their reflective surfaces, contribute to the generation of Non-Line-of-Sight (NLoS) communication paths. These NLOS paths involve phenomena such as reflection, diffraction, and scattering of transmitted signals. In the case of reflection, the transmitted signal may encounter obstructions, potentially causing signal blockage. In the case of diffraction and scattering, multiple versions of the original signal are received, each with its own time delay, phase, and frequency shifts. These multiple versions of the signal act as interference factors to the original transmitted and received signal, compounding the complexity of signal propagation in this environment.

The data packets transmitted between the heliostats and the central station are distinguished by having a relatively small payload; however, a considerable portion of their size is attributed to the packet headers. Consequently, saturating the network with packets featuring an inefficient utilization of their available packet length results in an escalation of network traffic and corresponding latency. Thus, employing a deliberate strategy to perform data aggregation at critical nodes within the multi-hop routing architecture can significantly mitigate network congestion and enhance latency performance.

### SUMMARY OF THE INVENTION

HELIOCOMM introduces a resilient wireless communication system based on the principles of Integrated Access and Backhaul (IAB) technology, entropy-based routing, dynamic spectrum management, and interference mitigation.

The first part of this invention introduces an Artificial Intelligent Network Reconfiguration and Routing system. It addresses limitations of static mesh networking, which often relies on distance-based routing. The innovation introduces a dynamic clustering-based network reconfiguration mechanism and an entropy-based routing algorithm. The approach is grounded in the recognition that network control metrics, such as heliostat energy availability, node failures, network traffic, latency requirements, shadowing, multipath effects, and RF/EM interference, vary significantly over time. To adapt to these fluctuations, an artificial intelligence reinforcement learning (RL) algorithm is devised. This RL algorithm empowers each heliostat to autonomously select its cluster or Access Point (AP) and enables real-time network reconfiguration based on current network control metrics. This autonomous and distributed RL-based network reconfiguration algorithm reduces signaling overhead with the central station, leading to lower network traffic and greater autonomy for wireless heliostats in network reconfiguration. Additionally, the algorithm is characterized by low computational complexity, resulting in reduced energy consumption and real-time execution on each heliostat's wireless module microcontroller.

This patent also presents an innovation in the field of wireless network routing, particularly designed for the Integrated Access and Backhaul (IAB) technology. The aim is to optimize packet reception at the central station's receiver by addressing the variable energy availability of heliostats in a cluster. The invention introduces an entropy-based routing algorithm, which is different from conventional mesh networking. In this approach, IAB nodes within the wireless backhaul not only serve as passive relays but actively amplify signals to ensure successful packet reception. However, this active role is contingent on sufficient energy availability, as insufficient energy would hamper other essential functions, such as controlling the heliostats mechanical parts. To manage this, the heliostat field is organized into zones, and each heliostat autonomously selects the best route through a neighboring heliostat within the same zone based on criteria like high energy availability and low network traffic. The algorithm computes entropy for each heliostat, where lower entropy signifies a more favorable route selection. The overall entropy for an end-to-end route is calculated based on the intermediate IAB nodes. The path with the lowest entropy is chosen for transmitting information to the central station's receiver. To reduce computational complexity and signaling overhead, the entropy-based routing algorithm can be executed at cluster-heads, and the optimal routes can then be disseminated to the cluster nodes. This innovation optimizes the wireless network's efficiency and reliability by dynamically selecting routes based on real-time conditions and energy availability, thus improving packet reception at the central station's receiver.

The third part of the invention described in this patent is an Integrated Access and Backhaul (IAB) technology aligned with the needs of wireless communication in Solar Tower Power Plants (STPPs) to support closed-loop control operation of the heliostats and designed to overcome the limitations of mesh networking technology. The key innovation of IAB technology lies in its ability to differentiate between access and wireless backhaul, allowing for dynamic allocation of the available spectrum based on network topology. The access link involves communication between a cluster-head heliostat or an Access Point (AP) and cluster nodes heliostats, while the wireless backhaul link includes peer-to-peer communication among strategically selected heliostats (IAB nodes) or APs to reach a central station's receiver (IAB donor). The technology employs a complex payoff function for each heliostat, considering factors like end-to-end data rate, latency, and energy consumption. An optimization problem is formulated to maximize energy efficiency (data rate over transmission power) and minimize latency, considering heliostats' energy availability and minimum latency requirements. IAB technology outperforms mesh networking by accommodating dynamic network topology and distinguishing between access and backhaul links.

### BRIEF DESCRIPTION OF DRAWINGS

FIG. 1 provides a visual representation of the segmentation and clustering procedures within the heliostat field. In FIG. 1(a), the triangular marker represents an Access Point (AP) within a single, representative segment. FIG. 1(b) depicts the clusters and their corresponding cluster-heads, denoted by solid rectangles, within one representative segment.

FIG. 2(a) displays the routing path from the Access Points (APs) to the Central Station (CS) spanning multiple representative segments. FIG. 2(b) showcases the end-to-end routes from the cluster-heads to the CS, including multiple representative clusters within each segment.

FIG. 3 represents the Integrated Access and Backhaul (IAB) architecture framework, where the IAB nodes are depicted as solid rectangles and the access heliostats as other rectangles. This architectural depiction emphasizes the communication links between access heliostats and their respective IAB nodes within the same cluster, as well as the end-to-end routes connecting the IAB nodes to either the IAB Donor or the Central Station (CS).

FIG. 4 presents the Algorithm for Cluster Formation.

FIG. 5 presents the entropy-based routing algorithm.

### DETAILED DESCRIPTION OF THE INVENTION

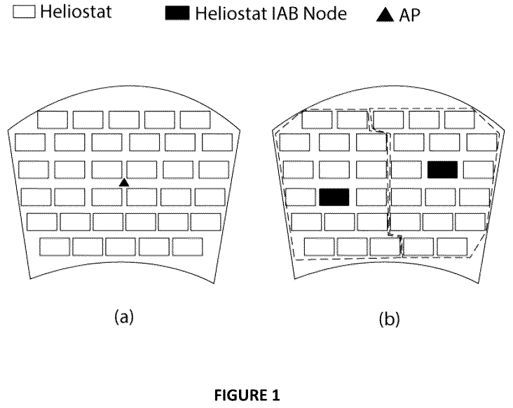

Reinforcement Learning-based Cluster Formation: The Solar Tower Power Plant (STPP), often referred to as the heliostat field, undergoes an initial division into segments based on an incremental radial distance criterion. This segmentation process groups heliostats with comparable distances from the central station (CS) together. Subsequently, a clustering approach, specifically a Reinforcement Learning (RL)-based clustering mechanism, can be applied following the segmentation. In the absence of RL-based clustering, Access Points (APs) can serve as the Integrated Access and Backhaul (IAB) nodes, as depicted in FIG. 1a. However, if clustering is performed subsequent to segmentation, each cluster will have a designated heliostat known as the cluster-head, which can act as an IAB node, as shown in FIG. 1b. The determination of cluster-heads is based on factors such as energy availability and closeness centrality. The choice between using APs or cluster-heads as the IAB nodes depends on various factors, including the total number of heliostats in the field, available budget, and the cost of implementation, among others.

In order to initiate the RL-based cluster formation, each heliostat utilizes the distance and channel gain values with other heliostats in the same segment. Each heliostat determines the following:

$$DG ( h , {h}^{′} ) = {w}_{1} D ( h , {h}^{′} ) + {w}_{2} \frac{1}{G ( h , {h}^{′} )} ,$$

with D(h, h′)=−log₂(d(h,h′)) and G(h,h′)=−log₂(g(h,h′)), where d(h, h′) and g(h, h′) are the distance and channel gain values between a heliostat h and h′, where h and h′ are in the same segment. w_{D} and w_{G} are the weights for the distance and the channel gain dependent terms respectively.

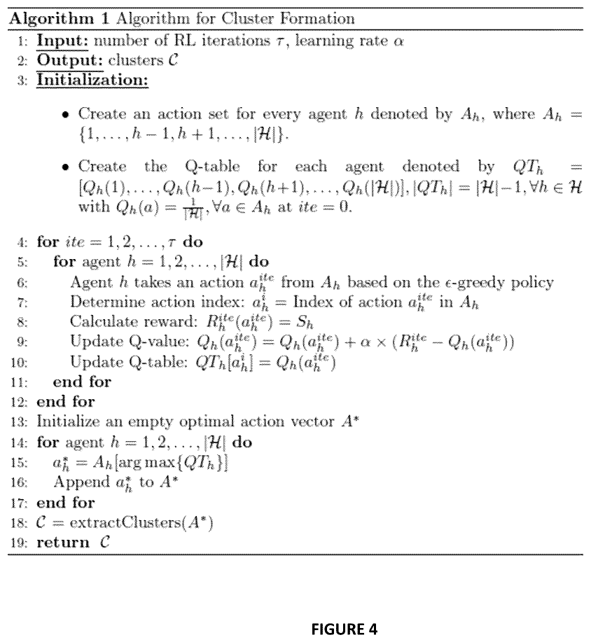

An intelligent clustering approach employs a reinforcement learning algorithm inspired by the principles of both the multi-armed Bandit and Q-learning algorithms. In this context, the RL-based clustering algorithm operates by considering that each heliostat acts as an agent, and each heliostat makes a selection of another heliostat from its segment to form a cluster with. This selection can be regarded as the action taken by each agent. FIG. 4 presents the RL algorithm employed for cluster determination within the heliostat field. Each agent, denoted as h, is associated with an action set Aₕ, which consists of the heliostat IDs belonging to the same segment. In each iteration ite of the algorithm, an agent h selects an action aₕ^{ite} from the set Aₕ and subsequently updates the Q-value Qₕ(aₕ^{ite}) for that specific action within the Q-table QTₕ associated with each heliostat h. The Q-value update rule is as follows: Qₕ(aₕ^{ite})=Qₕ(aₕ^{ite})+α×(Rₕ^{ite}−Qₕ(aₕ^{ite}). In the Q-value update rule, the parameter α represents the learning rate, which determines the degree to which the agent incorporates the newly obtained information over the old knowledge. Additionally, Rₕ^{ite} denotes the reward assigned to each agent h during iteration ite for the chosen action.

To compute the reward, the silhouette analysis is performed, which assesses the proximity of each heliostat within a cluster to the heliostats in neighboring clusters within the same segment, based on the value DG(h, h′). For each heliostat h in a cluster c, the average similarity with all the other heliostats in the same cluster is calculated as pₕ=

$$\frac{{\sum }_{∀ {h}^{′} ∈ c} DG ( h , {h}^{′} )}{\vert c \vert - 1} .$$

For all other clusters c′ within the same segment, the average similarity with all the other heliostats is computed as

$${q}_{h} = min \{ \frac{{\sum }_{∀ {h}^{′} ∈ {c}^{′}} DG ( h , {h}^{′} )}{\vert {c}^{′} \vert} \} .$$

The silhouette value of h is then determined as follows:

$${S}_{h} = \frac{{p}_{h} - {q}_{h}}{max \{ {p}_{h} , {q}_{h} \}}$$

Such that −1≤Sₕ≤1. If Sₕ>0, it indicates that heliostat is appropriately clustered. Heliostats with a high Sₕ value (approaching Sₕ→1) are exceptionally well-clustered. On the contrary, if Sₕ<0, it suggests that heliostat h might be more suitably placed in a different cluster within the same segment. When Sₕ=0, it means the heliostat is positioned between two neighboring clusters. The reward Rₕ^{ite} is calculated based on the silhouette analysis as follows: rₕ^{ite}(aₕ^{ite})=Sₕ.

To achieve a balance between exploration and exploitation, the ϵ-greedy strategy is employed. Under this strategy, the agents explore, meaning they take a random action, with a probability of ϵ, and otherwise, they exploit the policy they have already learned. Additionally, a decay scheme is applied to the value of ϵ, which evolves as follows: ϵ=d^{ite},

$$d = \sqrt[τ]{\frac{{ϵ}_{f}}{{ϵ}_{0}}} ,$$

where, ϵ₀ and ϵ_{f} are the initial and final values of ϵ, ite is the current iteration where the ite=1, 2, . . . , τ. Following the ϵ-greedy policy, we choose the action that maximizes the Q value with a probability of (1−ϵ), while with a probability of ϵ, we explore by randomly selecting an action. As each iteration progresses, e decreases, leading to a reduced likelihood of agents making suboptimal choices and a greater inclination towards exploiting the best available option.

Cluster-head Selection: The clusters are established through the RL-based cluster formation algorithm, as shown in FIG. 4. Subsequently, the cluster-heads are chosen from within these clusters by considering factors such as distance, channel gain, and energy availability values. A cluster c with heliostats denoted by the set [symbol] _{c} is considered for explaining the cluster-head selection process. The cluster-head selection process is initiated with the calculation of weights of each heliostat h, with other heliostats h′ in the cluster c as follows: wₕ_{_{c}}=DG(h_{c}, h_{c}′), ∀h′_{c}∈ [symbol] _{c}, h_{c}≠h′_{c}. Towards selecting the cluster-head ch_{c} of cluster c the concept of closeness centrality (CC) is proposed considering the factors of distance and channel gain as follows:

$$CC ( {h}_{c} ) = {\sum }_{{h}_{c} \neq {h}_{{c}^{′}} ∈ {ℋ}_{c}} [ \frac{{w}_{c} ( {h}_{c} , {h}_{{c}^{′}} )}{\vert {ℋ}_{c} \vert - 1} ] and score ( {h}_{c} ) = {w}_{CC} CC ( {h}_{c} ) + {w}_{E} \frac{E ( {h}_{c} )}{{E}_{c}^{max}} ,$$

where E_{c}^{max} is the maximum value of the available energy availability values of the heliostats in cluster c, as determined by their attached photovoltaic (PV) and battery, and w_{CC}, w_{E} are the weights of closeness centrality and energy availability values respectively. Based on the scores determined for each heliostat in the cluster c, the cluster-head ch_{c} is chosen to be the heliostat with the highest score as follows:

$${ch}_{c} = {arg max}_{∀ {h}_{c} ∈ {ℋ}_{c}} \{ score ( {h}_{c} ) \} .$$

The cluster-head selection process ensures that the cluster-head of each cluster is a heliostat that is closest to the other heliostats organized in the same cluster in terms of distance and channel gain along with having the highest available energy to execute the entropy-based routing.

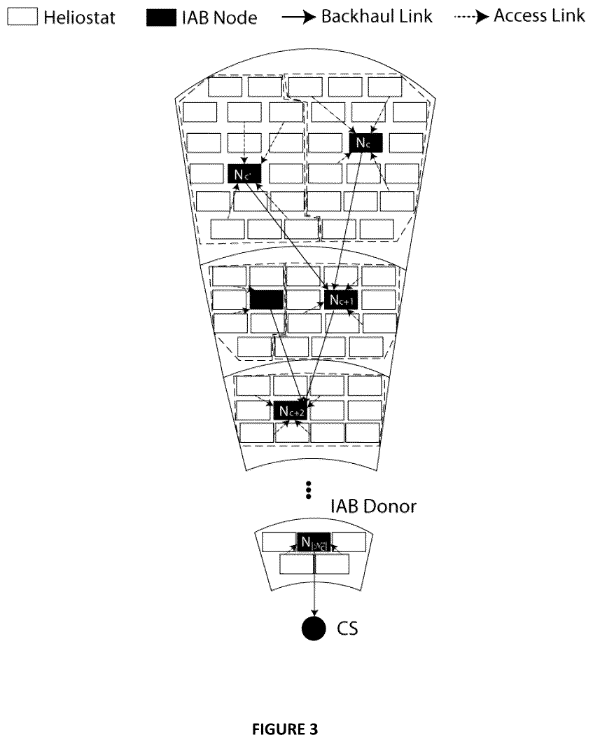

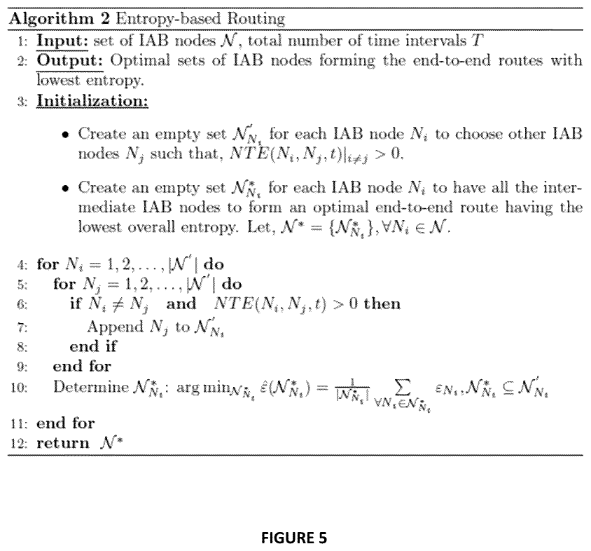

Entropy-based routing: A novel entropy-based routing algorithm is introduced to facilitate the reliable wireless transmission of packets from each Integrated Access and Backhaul (IAB) node to the Central Station (CS). FIG. 5 presents the entropy-based routing algorithm and FIG. 3 represents the Integrated Access and Backhaul (IAB) architecture framework. This routing algorithm considers factors such as energy availability and network traffic at the IAB nodes in order to construct an optimized end-to-end route from each IAB node to the CS. The entropy-based routing algorithm is executed by considering the set of IAB nodes represented as [symbol] ={N₁, . . . , N_{|} [symbol] _{|}}. The routing algorithm is initiated by determining the following:

$$NTE ( {N}_{i} , {N}_{j} , t ) {\vert}_{i \neq j} = \frac{{E}_{{N}_{j}} ( t )}{{NT}_{{N}_{j}} ( t )} - \frac{{E}_{{N}_{i}} ( t )}{{NT}_{{N}_{i}} ( t )} ,$$

where E_{N}_{ᵢ}, E_{N}_{ⱼ} are the energy availability values of the IAB nodes Nᵢ, Nⱼ respectively, and t is a discrete interval of time. This calculation ensures that an IAB node Nᵢ aims at selecting a neighbor IAB node Nⱼ to forward its traffic based on the higher energy availability and lower network traffic of the latter one, i.e., the lower entropy. It should be noted that, while choosing the IAB node Nⱼ in the next hop to forward traffic, the IAB node Nᵢ will only consider the set of IAB nodes [symbol] ′⊂ [symbol] such that, NTE(Nᵢ, Nⱼ, t)|ᵢ₊ⱼ>0, ∀Nⱼ∈ [symbol] ′. By considering the total number of discrete time intervals to be T, we have the following calculations:

$${a}_{{N}_{i} , {N}_{j} {\vert}_{i \neq j}} = \frac{1}{T} {\sum }_{t = 1}^{T} NTE ( {N}_{i} , {N}_{j} , t ) , {P}_{{N}_{i} , {N}_{j} {\vert}_{i \neq j}} = \frac{{a}_{{N}_{i} , {N}_{j} \vert i \neq j}}{{\sum }_{∀ {N}_{j} ∈ {𝒩}^{′}} {a}_{{N}_{i} , {N}_{j} {\vert}_{i \neq j}}} , and {ε}_{{N}_{i}} = - \frac{{\sum }_{∀ {N}_{j} ∈ {𝒩}^{′}} {P}_{{N}_{i} , {N}_{j} {\vert}_{i \neq j}} log [ {P}_{{N}_{i} , {N}_{j} {\vert}_{i \neq j}} ]}{log \vert {𝒩}^{′} \vert} .$$

Where, ε_{N}_{ᵢ} is the calculated entropy for the IAB node Nᵢ. So, each IAB node Nᵢ determines an end-to-end route to the CS. By using the entropy-based routing algorithm, it is ensured that the specific IAB nodes in an end-to-end route are chosen in such a way that the overall entropy of the end-to-end route is the lowest. The optimal end-to-end route is the route with the lowest overall entropy and the set of IAB nodes forming the optimal route is determined as follows:

$$arg {min}_{{𝒩}^{*}} \hat{ε} ( {𝒩}^{*} ) = \frac{1}{\vert {𝒩}^{*} \vert} {\sum }_{∀ {N}_{i} ∈ {𝒩}^{*}} {ε}_{{N}_{i}} .$$

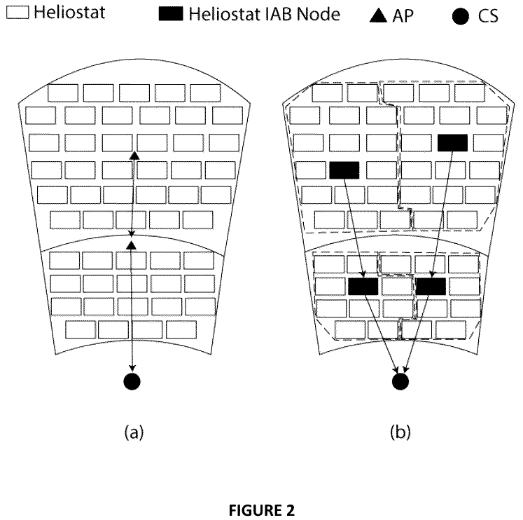

The entropy-based routing is summarized in FIG. 2.

Energy Efficiency Optimization: In our analysis of energy efficiency optimization, we focus on the scenario where clustering is carried out after segmentation. In this context, we consider a set of clusters denoted as [symbol] ={1, . . . , c, . . . , | [symbol] |} with each cluster having its corresponding IAB nodes N_{c}, where c belongs to the set of clusters [symbol] . However, it is important to note that if clustering is not conducted following the segmentation process, a similar analysis can be performed for the IAB nodes serving the segments individually, in which case one Access Point (AP) resides within each segment. After establishing the most efficient end-to-end data transmission route from a specific heliostat, denoted as h_{c} within a cluster c, through the Integrated Access and Backhaul (IAB) node(s) N_{c}, all the way to the central station's receiver, this section introduces a comprehensive wireless communication model. This model captures the data transmission, originating from heliostat h_{c}, passing through the IAB node N_{c} within its respective cluster, and extending towards the next destination, which could either be the subsequent cluster-head N_{c+1} or the central station's receiver. The analysis focuses on critical metrics, including end-to-end data rate, energy efficiency, and end-to-end latency. Within this framework, each IAB node engages in a sophisticated two-variable optimization task. The primary objective is to determine the optimal bandwidth splitting ratio, which determines the allocation of the available bandwidth resources across both the access and backhaul links. Additionally, the IAB nodes determine the optimal uplink transmission power required for efficiently relaying the data generated by the heliostats. With the derived optimized bandwidth splitting ratio and the IAB node's optimal uplink transmission power, the access heliostats subsequently tackle their own optimization challenge. This process determines their optimal uplink transmission power in a distributed manner.

Each cluster, denoted as c, is allocated a specific channel with a bandwidth of B_{c}. This bandwidth, B_{c}, is divided into two parts, with a ratio of ω_{c} assigned to the access link and (1−ω_{c}) allocated to the backhaul link. To facilitate the data forwarding process by an Integrated Access and Backhaul (IAB) node N_{c}, based on the routing set of IAB node

$${𝒩}_{{N}_{c}}^{*} = \{ {N}_{c + 1} , … , {N}_{\vert {𝒩}_{{N}_{c}}^{*} \vert} \} ,$$

we establish two distinct sets: [symbol] _{N}_{_{c}}^{BH} and [symbol] _{N}_{_{c}}^{FH}, where [symbol] _{N}_{_{c}}^{BH} represents the set of nodes associated with the backhaul of N_{c}, and [symbol] _{N}_{_{c}}^{FH} represents the set of nodes whose next single-hop destination aligns with that of N_{c}. Without loss of generality, we assume that the heliostats' channel gains gₕ_{_{c}} are sorted and the Non-Orthogonal Multiple Access (NOMA) technique is adopted in both the access and the backhaul links, by implementing the Successive Interference Cancellation (SIC) technique at the receiver. A heliostat's h, achieved data rate through the wireless access (Rₕ_{_{c}}^{AC}) is as follows:

$${R}_{{h}_{c}}^{A C} = {ω}_{c} {B}_{c} {log}_{2} ( 1 + \frac{{g}_{{h}_{c}} {P}_{{h}_{c}}}{{\sum }_{∀ i ∈ {I}_{{h}_{c}}} {g}_{i} {P}_{i} + {ω}_{c} {B}_{c} {N}_{0}} ) ,$$

where, Pₕ_{_{c}} [W] is the uplink transmission power of heliostat h_{c} in cluster c, No [dBm/Hz] is the power spectral density of the zero-mean Additive White Gaussian Noise (AWGN), and [symbol] ₕ_{_{c}} denotes the set of interference sources while receiving a signal from h_{c} at the access link following the NOMA and SIC techniques. The corresponding transmission delay tₕ_{_{c}}^{AC}[sec] of heliostat h_{c} to transmit its data Dh, to the corresponding IAB node N_{c} is as follows:

$${t}_{{h}_{c}}^{AC} = \frac{{D}_{{h}_{c}}}{{R}_{{h}_{c}}^{AC}} .$$

Let, P_{N}_{_{c}}[W] indicate the IAB node's N_{c} of cluster c transmission power for forwarding its received data (from the access heliostats) to the immediate next IAB node N_{c+1} or the central station's receiver. The IAB node's N_{c} achieved date rate in the backhaul is given as follows:

$${R}_{{N}_{c}}^{B H} = ( 1 - {ω}_{c} ) {B}_{c} {log}_{2} ( 1 + \frac{{g}_{{N}_{c}} {P}_{{N}_{c}}}{{\sum }_{∀ i ∈ {I}_{{N}_{c}}} {g}_{i} {P}_{i} + ( 1 - {ω}_{c} ) {B}_{c} {N}_{0}} ) ,$$

where g_{N}_{_{c}} is the channel gain between N_{c} and its corresponding single-hop IAB node/central station's receiver during data forwarding process, and [symbol] _{N}_{_{c}} is the set of interference sources while receiving a signal from the IAB node N_{c} at the backhaul link following the NOMA and SIC techniques. The backhaul transmission of IAB node N_{c} includes both the data generated by the access heliostats and the data from the backhaul connections of IAB node N_{c}. Consequently, the achieved data rate for the IAB node N_{c} in the backhaul link, denoted as R_{N}_{_{c}}^{BH}, can be fairly distributed among the access heliostats and any connected backhaul IAB nodes (if applicable) of IAB node N_{c}. This fair distribution is determined by

$$\frac{{R}_{k}}{{\sum }_{∀ {h}_{c} ∈ {ℋ}_{c}} {R}_{{h}_{c}}^{A C} + {\sum }_{∀ {c}^{′} ∈ {𝒩}_{{N}_{c}}^{BH}} {R}_{{N}_{{c}^{′}}}^{BH}} ,$$

where Rₖ is the rate at which access or backhaul data are received at the IAB node N_{c} such that Rₖ=Rₕ_{_{c}}^{AC} for any access heliostat in [symbol] _{c} or Rₖ=R_{N}_{_{c′}}^{BH} for any IAB node at the backhaul connection defined by the set [symbol] _{N}_{_{c}}^{BH}. The corresponding backhaul latency (transmission delay for the data to reach the IAB node N_{c+1}) of heliostat h_{c} is represented as:

$${t}_{{h}_{c}}^{BH} = \frac{{D}_{{h}_{c}}}{\frac{{R}_{{h}_{c}}^{AC}}{{\sum }_{∀ {h}_{c} ∈ {ℋ}_{c}} {R}_{{h}_{c}}^{A C} + {\sum }_{∀ {c}^{′} ∈ {𝒩}_{{N}_{c}}^{BH}} {R}_{{N}_{{c}^{′}}}^{BH}} {R}_{{N}_{c}}^{BH}} .$$

Upon the reception of data from IAB node N_{c}, the one-hop destination IAB node N_{c+1} will allocate a portion of its backhaul rate to its access and backhaul connection IAB nodes in a proportional manner. Consequently, the latency experienced by N in the backhaul of N_{c+1} can be determined as follows:

$${t}_{{N}_{c + 1}} = \frac{{\sum }_{{h}_{c} ∈ {ℋ}_{c}} {D}_{{h}_{c}}}{\frac{{R}_{{N}_{c}}^{BH}}{{\sum }_{∀ {h}_{c + 1} ∈ {ℋ}_{c + 1}} {R}_{{h}_{c + 1}}^{A C} + {\sum }_{∀ {c}^{′} ∈ {𝒩}_{{N}_{c + 1}}^{BH}} {R}_{{N}_{{c}^{′}}}^{BH}} {R}_{{N}_{c + 1}}^{BH}} .$$

For all the other IAB nodes Na in the routing set of Ne such that n={N_{c+2}, . . . , | [symbol] *_{N}_{_{c}}}, the backhaul latency is as follows:

$${t}_{{N}_{n}}^{BH} = \frac{{D}_{{N}_{n - 1}}}{\frac{{R}_{{N}_{n - 1}}^{BH}}{{\sum }_{∀ {h}_{n} ∈ {ℋ}_{n}} {R}_{{h}_{n}}^{A C} + {\sum }_{∀ {c}^{′} ∈ {𝒩}_{{N}_{n}}^{BH}} {R}_{{N}_{{c}^{′}}}^{BH}} {R}_{{N}_{n}}^{BH}} ,$$

resulting in an end-to-end latency of h_{c} given as: tₕ_{_{c}}^{E2E}=tₕ_{_{c}}^{AC}+tₕ_{_{c}}^{BH}+_{N}_{_{c}}₊₁^{BH}+Σ_{∀n∈{N}_{_{c+2}}_{, . . . ,|} [symbol] _{*N}_{_{c}}_{|}}t_{N}_{ₙ}^{BH}. Accordingly, a heliostat's h, end-to-end achieved data rate Rₕ_{_{c}}^{E2E} is given as:

$${R}_{{h}_{c}}^{E 2 E} = min ( \begin{matrix}{R}_{{h}_{c}}^{AC} , \\ \frac{{R}_{{h}_{c}}^{AC}}{{\sum }_{∀ {h}_{c} ∈ {ℋ}_{c}} {R}_{{h}_{c}}^{A C} + {\sum }_{∀ {c}^{′} ∈ {𝒩}_{{N}_{c}}^{BH}} {R}_{{N}_{{c}^{′}}}^{BH}} , \\ \frac{{R}_{{N}_{c}}^{BH}}{{\sum }_{∀ {h}_{c + 1} ∈ {ℋ}_{c + 1}} {R}_{{h}_{c + 1}}^{A C} + {\sum }_{∀ {c}^{′} ∈ {𝒩}_{{N}_{c + 1}}^{BH}} {R}_{{N}_{{c}^{′}}}^{BH}} {R}_{{N}_{c + 1}}^{BH} , \\ {\{ \frac{{R}_{{N}_{n - 1}}}{{\sum }_{∀ {h}_{n} ∈ {ℋ}_{n}} {R}_{{h}_{n}}^{A C} + {\sum }_{∀ {c}^{′} ∈ {𝒩}_{{N}_{n}}^{BH}} {R}_{{N}_{{c}^{′}}}^{BH}} {R}_{{N}_{n}}^{BH} \}}_{∀ n = \{ {N}_{c + 1 , … , \vert {𝒩}_{{N}_{c}}^{*} \vert} \}}\end{matrix} )$$

The IAB node N_{c} determines the optimal bandwidth splitting ratio ω*_{c} and its optimal transmission power P*_{N}_{_{c}}, given the uplink transmission power of the heliostats h_{c} in its cluster and other IAB nodes in the backhaul connection of the IAB node N_{c} defined by the set [symbol] _{N}_{_{c}}^{BH}. The corresponding optimization problem is formulated as follows:

$${max}_{{ω}_{c} , {P}_{{N}_{c}}} {EE}_{{N}_{c}} ( {ω}_{c} , {P}_{{N}_{c}} ) = \frac{{R}_{{N}_{c}}^{BH}}{{\sum }_{∀ h ∈ {ℋ}_{c}} {P}_{{h}_{c}} + {\sum }_{∀ {c}^{′} ∈ {𝒩}_{{N}_{c}}^{BH}} {P}_{{N}_{{c}^{′}}} + {P}_{{N}_{c}}} ,$$

such that, 0≤ω_{c}≤1, P_{N}_{_{c}}≤P^{max}, P_{N}_{_{c+1}}^{s}≥P^{s}, and the tₕ_{_{c}}^{E2E}≤t^{max}, ∀h_{c}∈ [symbol] _{c}. Where, P^{s}[W] is the receiver's sensitivity that ensures the received power level is sufficient to decode the received signal given the received signal power P_{N}_{_{c+1}} from N_{c} is higher than P^{s}, and P^{max} is the maximum transmission power as determined by the technical characteristics of the wireless module. Once the IAB node communicates the optimal bandwidth splitting ratio to the heliostats within its cluster, the heliostats initiate their decision-making process. The objective for each heliostat is to independently maximize its energy efficiency within the access network by optimizing its uplink transmission power. The utility function for each heliostat h_{c} in cluster c is articulated as follows:

$${EE}_{{h}_{c}} ( {P}_{{h}_{c}} , {P}_{- {h}_{c}} ) = \frac{{R}_{{h}_{c}}^{A C}}{{P}_{{h}_{c}} + {P}_{c}} ,$$

where, P₋ₕ_{_{c}}=[P₁, . . . , Pₕ_{_{c}}₋₁, Pₕ_{_{c}}₊₁, . . . , P_{|} [symbol] _{_{c}}|] is the vector of uplink transmission powers of all heliostats in the cluster c except for heliostat h_{c}. The corresponding optimization problem solved by each heliostat h_{c} is formulated as: max EEₕ_{_{c}}(Pₕ_{_{c}}, P^{-h}_{c}), such that Pₕ_{_{c}}_{,N}_{_{c}}^{s}≥P^{s}, ∀h_{c}∈ [symbol] _{c}, and tₕ_{_{c}}^{E2E}≤t^{max}, ∀h_{c}∈ [symbol] _{c}. Where, Pₕ_{_{c}}_{,N}_{_{c}}^{s} is the received power at the IAB node from heliostat h_{c}.

The invention is further described in HELIOCOMM: A Resilient Wireless Heliostats Communication System, Dec. 12, 2023, the entirety which is incorporated by reference.

While the disclosure is susceptible to various modifications and alternative forms, specific exemplary embodiments of the invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

1. A resilient wireless communication system for Solar Tower Power Plants (STPPs) consisting of wireless heliostats, powered by PV and communicating among each other and the CS in a wireless manner, based on the principles of Integrated Access and Backhaul (IAB) technology, entropy-based routing, dynamic spectrum management, and interference mitigation.

2. A resilient wireless communication system introducing an Artificial Intelligent Network Reconfiguration and Routing system that autonomously reconfigures a wireless network based on current network control metrics, comprising:
a dynamic clustering-based network reconfiguration mechanism for forming and dissolving clusters of network nodes, responsive to fluctuations in network control metrics;
an entropy-based routing algorithm for selecting optimal routes for data transmission within the wireless network;
an artificial intelligence reinforcement learning (RL) algorithm that enables each heliostat to autonomously select a cluster or Access Point (AP) and reconfigure the network in real-time based on current network control metrics;
a feature for low-energy consumption and real-time execution, allowing the RL algorithm to execute on each heliostat's wireless module microcontroller, thereby reducing energy consumption and improving network autonomy.

3. The wireless communication system of claim 2, wherein the fluctuations in network control metrics comprise one or more of the at least one heliostat's energy availability, node failures, network traffic, latency requirements, shadowing, multipath effects, and RF/EM interference.

4. The wireless communication system of claim 2, wherein the entropy-based routing algorithm computes entropy for each network node and determining routes with lower entropy for information transmission.

5. The wireless communication system of claim 2, wherein the RL algorithm reduces signaling overhead and computational complexity.

6. A wireless network routing system, specifically designed for Integrated Access and Backhaul (IAB) technology, optimizing packet reception at a central station's receiver, comprising the steps of:
providing an entropy-based routing algorithm that distinguishes itself from conventional mesh networking, ensuring successful packet reception at the central station's receiver by actively amplifying signals at IAB nodes, provided sufficient energy availability;
dividing by a network organization system the heliostat field into zones, allowing each heliostat to autonomously select the best route through a neighboring heliostat in the same zone;
calculating entropy for each heliostat to evaluate route favorability, with lower entropy indicating more favorable route selection;
calculating overall entropy for an end-to-end route based on intermediate IAB nodes;
executing the entropy-based routing algorithm at cluster-heads to reduce computational complexity and signaling overhead;
enhancing wireless network efficiency and reliability through dynamic route selection based on real-time conditions and energy availability.

7. The wireless network routing system of claim 6, wherein the network organization system integrates energy availability and network traffic.

8. The wireless network routing system of claim 6, wherein calculation of the overall entropy allows the lowest entropy path to be chosen for transmitting information to the central station's receiver.

9. The wireless network routing system of claim 6, wherein the entropy-based routing algorithm enables optimal route dissemination to cluster nodes.

10. The wireless network routing system of claim 6, wherein enhancement of wireless network efficiency provides for improved packet reception at the central station's receiver.

11. An Integrated Access and Backhaul (IAB) technology designed to support wireless communication in Solar Tower Power Plants (STPPs) for closed-loop control operation of heliostats, with the ability to dynamically allocate available spectrum based on network topology, comprising the step of:
differentiating between access and wireless backhaul links, enabling dynamic allocation of spectrum based on network topology;
using an optimization problem formulation to maximize energy efficiency (data rate over transmission power) and minimize latency;
accommodating dynamic network topology to ensure efficient differentiation between access and backhaul links, outperforming mesh networking technology;
using a complex payoff function for each heliostat to calculate the most favorable link configuration;
selecting the optimal link configuration using a system responsive to heliostats' energy availability and minimum latency requirements.

12. The IAB technology of claim 11, wherein optimization problem formulation considers factors comprising as heliostats' energy availability and minimum latency requirements.

13. The IAB technology of claim 11, wherein the payoff function considers end-to-end data rate, latency, and energy consumption.

14. The IAB technology of claim 11, wherein responsiveness allows for enhanced overall network efficiency and minimizing latency in STPPs.
